(19) United States
(12) Patent Application Publication
(10) Pub. No.: US 2024/0376607 A1
(43) Pub. Date: Nov. 14, 2024

(54) METHOD AND COMPOSITION FOR TREATING DILUTION STEAM GENERATOR SYSTEMS

(71) Applicant: BL Technologies, Inc., Minnetonka, MN (US)

(72) Inventors: Mahesh Budhathoki, Minnetonka, MN (US); Donald Meskers, Jr., Minnetonka, MN (US); Nimeshkumar Patel, Minnetonka, MN (US)

(21) Appl. No.: 18/689,711

(22) PCT Filed: Sep. 7, 2022
(86) PCT No.: PCT/US2022/076003

§ 371 Date: Mar. 6, 2024

Related U.S. Application Data
(60) Provisional application No. 63/242,983, filed on Sep. 10, 2021.

(30) Foreign Application Priority Data
Sep. 7, 2022 (WO) PCT/US2022/076003

(51) Int. Cl. C23F 11/12; C23F 11/14; C23F 14/02

(52) U.S. Cl. CPC C23F 11/126; C23F 11/141; C23F 14/02

(57) ABSTRACT

A treatment composition having anti-foulant and anti-corrosion properties is provided. The composition having a fatty amine and a diacid, where the diacid is a succinic acid or a linear saturated dicarboxylic acid having the formula: HO₂C(CH₂)ₙCO₂H where n is a positive integer of at least 6. A method for treating dilution steam generator system is also provided.

### CROSS REFERENCE TO RELATED APPLICATION

This application is a U.S. National Stage Entry of International Application No. PCT/US2022/076003 filed Sep. 7, 2022, which claims the priority benefit of U.S. Provisional Patent Application Ser. No. 63/242,983 filed Sep. 10, 2021, the entirety of which is incorporated herein by reference.

### FIELD OF INVENTION

The disclosed technology provides for anti-corrosion and anti-fouling treatment, and more specifically, an anti-corrosion and anti-fouling treatment for dilution steam generator systems.

### BACKGROUND OF THE INVENTION

A dilution steam generator (DSG) is an integral part of ethylene processing plants. Steam from the DSG is used in pyrolytic cracking and process waters from the pyrolysis process is recycled as feed water to the DSG. Unlike typical boiler applications, the DSG boiler feed water is contaminated with oils, polyaromatic hydrocarbons, and elevated levels of low molecular weight organic acids (LOMAs), sodium, iron, sulfate, and so forth.

These contaminants can lead to fouling of equipment. Low pH corrosion by LOMAs along with fouling by organic polymerization and corrosion products are common issues encountered in DSG systems.

Polymeric deposit control agents are frequently added to the feedwaters of boilers to inhibit the formation of deposits on surfaces and prevent deposition within the boiler system. Polyamines provide corrosion protection by forming a hydrophobic barrier between corrosive species and metal/metal oxides when applied to the boiler system. Polyamines are also volatile and protect steam-touched metal surfaces from corrosion.

However, unlike typical boiler applications, which have a relatively pure feed water, the amount of treatment (i.e. dose) required to inhibit the fouling and corrosion from elevated levels of contaminants/corrosive species and oil matrix in a DSG system is significantly higher (at least 5 times higher) than treatment needed for traditional boilers.

In addition to increased treatment costs, elevated levels of fatty amines or polyamines can foul the boiler equipment and online monitoring instrumentation and analyzers. Discharge water with high amounts of polyamines have environmental concerns, as these treatment compounds can be toxic to aquatic life.

Thus, there is a need in the industry to reduce fouling and corrosion in steam generating systems, including dilution steam generator systems, with cost-effective treatment that is easy to apply and has reduced environmental concerns.

### SUMMARY OF THE INVENTION

The disclosed technology provides for anti-fouling and anti-corrosion treatment for steam generating systems.

In one aspect of the disclosed technology, a treatment composition is provided. The composition comprises a fatty amine and a diacid, wherein the diacid comprises a succinic acid or a linear saturated dicarboxylic acid having the formula: HO₂C(CH₂)ₙCO₂H, wherein n is a positive integer of at least 6.

In some embodiments, the fatty amine comprises a polyamine having a hydrocarbon chain of at least 12 carbon atoms. In some embodiments, the fatty amine comprises a diamine having a C₁₂-C₁₈ hydrocarbon chain.

In some embodiments, the diacid comprises a succinic acid. In some embodiments, the succinic acid comprises octenyl succinic acid or dodecenyl succinic acid. In some embodiments, n is in a range from 7 to 18.

In some embodiments, the fatty amine comprises a 9-ene-N-propylamino-1-octadenamine. In some embodiments, the composition comprises a polyamine and octenyl succinic acid.

In some embodiments, a molar ratio of the fatty amine to the di-acid is in a range of from about 1:100 to about 100:1. In some embodiments, the treatment composition is water soluble.

In yet another aspect of the disclosed technology, a method for controlling corrosion and/or deposit formation along structural parts of a dilution steam generator system is provided. The method comprises adding a treatment composition to an aqueous medium, wherein the treatment composition comprises a fatty amine and a diacid, wherein the diacid comprises a succinic acid or a linear saturated dicarboxylic acid having the formula: HO₂C(CH₂)ₙCO₂H, wherein n is a positive integer of at least 6.

In some embodiments, the treatment composition forms a film on the structural parts of a liquid section and a vapor section of the dilution steam generator system.

In some embodiments, the fatty amine comprises a polyamine with a hydrocarbon chain having at least 12 carbon atoms. In some embodiments, the fatty amine comprises a diamine having a C₁₂-C₁₈ hydrocarbon chain. In some embodiments, the diacid comprises a succinic acid. In some embodiments, the succinic acid comprises octenyl succinic acid or dodecenyl succinic acid.

In some embodiments, the fatty amine comprises a 9-ene-N-propylamino-1-octadenamine. In some embodiments, the treatment composition comprises a polyamine and octenyl succinic acid.

In some embodiments, a molar ratio of the fatty amine and the di-acid is in a range of from about 1:100 to about 100:1. In some embodiments, the treatment composition is water soluble.

In yet another aspect of the disclosed technology, a method for preparing a treatment composition is provided. The method comprises mixing a fatty amine with a diacid, wherein the diacid comprises a succinic acid or a linear saturated dicarboxylic acid having the formula: HO₂C(CH₂)ₙCO₂H wherein n is a positive integer of at least 6. In some embodiments, the treatment composition is water soluble.

### BRIEF DESCRIPTION OF THE DRAWINGS

FIG. 1 is a graph showing the corrosion rates measured in milli-inch per year (mpy) vs. time (hours) for comparative treatment samples at 100 ppm.

FIG. 2 is a graph showing the corrosion rates measured in milli-inch per year (mpy) vs. time (hours) for treatment samples in varying amounts.

FIG. 3 is a graph showing the corrosion rates measured in milli-inch per year (mpy) vs. time (hours) for treatment samples at 50 ppm.

FIG. 4 is a graph showing the corrosion rates measured in milli-inch per year (mpy) vs. time (hours) for treatment samples at 50 ppm.

FIG. 5 is a graph showing the corrosion rates measured in milli-inch per year (mpy) vs. time (hours) for treatment samples at different pH measurements.

### DETAILED DESCRIPTION OF EXEMPLARY EMBODIMENTS

The disclosed technology provides for composition and method for treating dilution steam generator (DSG) systems. The treatment according to the disclosed technology reduces fouling deposits and prevents overall corrosion in the liquid and steam sections of the dilution steam generator system.

In the following specification and the claims, reference will be made to a number of terms, which shall be defined to have the following meanings.

The singular forms “a”, “an”, and “the” include plural references unless the context clearly dictates otherwise. As used herein, the term “or” is not meant to be exclusive and refers to at least one of the referenced components being present and includes instances in which a combination of the referenced components may be present, unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

Steam generating systems produce steam from an aqueous medium, such as water. The steam generating system includes a liquid section that is in contact with an aqueous medium and a steam section in contact with a vapor phase of the aqueous medium. The steam generating system includes walls of metal and other structural parts that are exposed to or come into contact with the aqueous medium and vapor phase. A steam generating system may include industrial boiler systems and dilution steam generators (DSG) systems.

Dilution Steam Generator (DSG) systems are used in ethylene processing plants to provide steam for pyrolytic cracking. Process water recovered from the pyrolytic cracking process may be recycled as feed water to the DSG for steam generation. The recycled process water contains contaminants from the pyrolysis process, such as oils, polyaromatic hydrocarbons, low molecular weight organic acids (LOMAs), sodium, calcium, magnesium, iron, calcium carbonate, silica and sulfate. These contaminants can lead to fouling and deposition on interior surfaces of the DSG.

Steam generating systems, such as a DSG, typically operate and produce steam at temperatures in the range from about 180° C. to about 190° C. and pressures of about 7 bars to about 10 bars. In some embodiments, the temperature is in a range from about 185° C. to about 190° C. In another embodiment, the steam generating system operates at a pressure of about 8 bars to about 10 bars. In some embodiments, a DSG operates at a pressure of about 8 bars and a temperature of about 185° C.

According to the presently disclosed technology, it was surprisingly discovered that the combination of a fatty amine compound with a diacid compound created a synergistic effect and produced a treatment composition having unexpected properties. While each component offers some treatment protection, the combination of the compounds produced a composition with enhanced treatment properties. Although not intending to be bound by theory, it is believed that the fatty amines co-adsorb with the diacid compound on metal surfaces to form a protective film on the metal surfaces and structural parts of both the liquid and steam sections of the DSG systems, thus eliminating the need of higher dosage of polyamine to get a desired level of corrosion protection. The enhanced corrosion protection of the treatment composition is cost effective and provides for overall corrosion protection to DSG systems utilizing recycled feed water containing organic and inorganic contaminants, without the need for higher levels (i.e. higher doses) of treatment.

In one aspect of the disclosed technology, a treatment composition is provided. The treatment composition reduces corrosion and fouling deposits and has anti-foulant properties, as well as disperses and removes organic fouling within DSG systems. The treatment composition forms a protective film on inside metal surfaces or structural components of the DSG system. The film can form in both the liquid and steam sections of the DSG systems and provides overall corrosion protection. In some embodiments, the treatment composition is water-soluble.

In some embodiments, the treatment composition comprises a fatty amine and a diacid. Since the DSG water contains oil contaminants and the polyamine is oil soluble, it is believed that that majority of the polyamine will partition into the oil phase. This limits polyamine availability in water phase to provide corrosion protection to the water touched metal surface. As a result, a polyamine-only treatment is required to be dosed at higher level. However, with the addition of the synergistic treatment composition as described herein, the polyamine's water solubility is improved allowing more polyamine molecules to be available in water phase to form a corrosion protective film on metals or metal oxides. At the same time, diacids, being a surface-active agent, co-adsorb together with the polyamine on metal surface and can significantly reduce the amount of treatment required to provide a desired level of corrosion protection.

In some embodiments, the diacid comprises a succinic acid or a linear saturated dicarboxylic acid having the formula: HO₂C(CH₂)ₙCO₂H where n is a positive integer of at least 6.

In some embodiments, the fatty amine comprises a linear amine with a hydrocarbon chain having at least 12 carbon atoms. In other embodiments, the fatty amine comprises a linear amine with a C₁₂-C₁₈ hydrocarbon chain. The hydrocarbon chain comprises saturated or unsaturated aliphatic groups. In some embodiments, the fatty amine is a polyamine or a diamine. Examples of suitable fatty amines include, but are not limited to, dodecylamine, tridecylamine, oleyl amine, linoleamine, 9-ene-N-propylamino-1-octadenamine and mixtures thereof. It should be understood that for corrosion inhibition, suitable longer chain fatty amines (i.e., C>12), are required to form a corrosion protective hydrophobic film on metal surfaces.

In some embodiments, the diacid is a succinic acid. It should be understood that although monoacids could be used in typical boiler systems, diacids are more suitable for the DSG system that contains oil contaminants. This is due to the fact that diacids have two carboxylic acid functional groups, which increase their affinity for the water thereby preventing diacids for partitioning into the oil phase. As such, the more treatment that is available in liquid phase indicates lower required treatment dosage level.

In other embodiments, the succinic acid is an octenyl succinic acid or dodecenyl succinic acid. In some embodiments, the diacid is a dicarboxylic acid having the formula: HO₂C(CH₂)ₙCO₂H where n is a positive integer of at least 6. In other embodiments, n is a positive integer from 7 to 18. In another embodiment, the linear saturated fatty diacid may be nonanedioic acid.

In some embodiments, the treatment composition is prepared by mixing the components to form a composition. In some embodiments, the fatty amine and diacid are mixed at an elevated temperature to form the blended composition. In some embodiments, the components are mixed and heated to about 50° C. to form the blend. In other embodiments, the treatment composition is blended at a temperature ranging from about room temperature (˜20-23° C.) to about 50° C.

In some embodiments, the treatment composition is water soluble. As previously mentioned, for the DSG system that contains oil, a treatment, such as that disclosed herein, is required to prevent loss of treatment to the oil phase. The treatment composition as described herein is water soluble, and does not get consumed into the oil phase, which synergistically provides corrosion protection to the water-touched metal surfaces as both polyamines and diacids co-adsorb on metal surface.

In some embodiments, the treatment composition is blended in a molar ratio suitable for neutralizing the fatty amine and forming a composition. As it relates to the DSG system, the objective is to minimize the use of polyamine without sacrificing the performance. Therefore, in some embodiments, the disclosed treatment composition (i.e., diacid to polyamine mole ratio is >1) the fatty amines are fully neutralized.

In some embodiments, the molar ratio of the fatty amine to the diacid is in a range from about 1:100 to about 100:1. In other embodiments, the molar ratio of the fatty amine to the diacid is in a range from about 1 to about 1:9. In one embodiment, the molar ratio of the fatty amine to the diacid is in a range of from about 1:1 to about 1:5. In another embodiment, the molar ratio of the fatty amine to the diacid is in a range of from about 1:1 to about 1:3. In another embodiment, the molar ratio of the fatty amine to the diacid is in a range of from about 1:1 to about 1:2. In other embodiments, the blend comprises the fatty amine and the diacid in a 1:1 molar ratio.

In yet another aspect of the disclosed technology, a method for controlling deposit formation along structural parts of a DSG system is provided. The structural parts are exposed to an aqueous medium under DSG conditions by adding a treatment composition to the aqueous medium. The aqueous medium comprises water, such as feed water, for the DSG system.

In some embodiments, the aqueous medium comprises recycled process water from a pyrolytic cracking process. The aqueous medium may include contaminates, such as, but not limited to, oils, polyaromatic hydrocarbons, sodium, calcium, magnesium, iron, calcium carbonate, silica and sulfate. The aqueous medium comprises low molecular weight organic acids (LOMAs), such as, but not limited to, acetic acid, butyric acid, formic acid, glycolic acid, and propionic acid.

In some embodiments, the aqueous medium is heated or is maintained at room temperature (i.e. from about 20° C. to about 23° C.). In some embodiments, the aqueous medium is heated to a temperature from about 80° C. to about 180° C. In other embodiments, the temperature of the aqueous medium ranges from about 25° C. to about 180° C.

It should be understood that the treatment composition can be added to the aqueous medium by any conventional manner recognized in the art. The treatment composition is water soluble and, in some embodiments, is added directly to the aqueous medium, such as, but not limited to, by direct injection.

In some embodiments, the treatment composition of the present method is added to the aqueous medium before the aqueous medium enters or contacts the DSG system, and in other embodiments, is added to the aqueous medium concurrently as the aqueous medium enters the DSG system. In other embodiments, the treatment composition is added to the aqueous medium after the aqueous medium has contacted the DSG system, and in other embodiments, the treatment composition is added to the aqueous medium as a solution or dispersion.

The enhanced corrosion protection of the disclosed treatment composition provides cost-effective treatment for overall corrosion protection to a DSG system.

In some embodiments, the treatment composition is added to the aqueous medium in an effective amount to provide anti-corrosion and anti-fouling protection to the DSG system. In one embodiment, the treatment composition is added to the aqueous medium of the DSG system in an amount of about 1 ppm by weight to about 200 ppm by weight based upon one million parts of the water in the DSG system. In another embodiment, the treatment composition may be added in an amount from about 5 ppm by weight to about 100 ppm by weight. In another embodiment, the treatment composition may be added in an amount from about 10 ppm by weight to about 100 ppm by weight. In another embodiment, the treatment composition may be added in an amount from about 15 ppm by weight to about 100 ppm by weight. In another embodiment, the treatment composition may be added in an amount of from about 20 ppm by weight to about 100 ppm by weight. In another embodiment, the treatment composition may be added in an amount of from about 25 ppm by weight to about 100 ppm by weight. In another embodiment, the treatment composition may be added in an amount from about 25 ppm by weight to about 50 ppm by weight. In another embodiment, the treatment composition may be added in an amount from about 50 ppm by weight to about 100 ppm by weight. All weights are the active treatment in the composition and are based upon one million parts of the water in the steam generating system. In some embodiments, the treatment composition is added to the aqueous medium in a batch mode, a one-shot application, or is continuously added to the aqueous medium.

The disclosed composition and method of the treatment produces a blend, thus allowing for easy application to an aqueous medium without the need for special equipment, such as, for example, pumps, to mix the treatment composition with the aqueous medium, which may be required for mixing or distributing the individual components in the aqueous medium. In some embodiments, the blend is water-soluble. For example, a fatty amine can be in the form of a gel and the diacid may be in solid form.

The disclosed treatment composition and methods for treating DSG systems use less of the fatty amine component, which reduces the environmental impact of the aqueous medium in the steam generated system. As compared to the typical boiler system, the amount of polyamine required to provide a desired level of corrosion protection is much higher in the DSG system, and therefore, requires polyamine to be fed at the higher level. However, over-feeding polyamine is also associated with the organic deposit formation in the system, which could force plants to shut down for clean-up. Apart from this, under-deposit corrosion may also occur in the even of deposit formation. Therefore, the present technology allows for a reduction in the amount of polyamine within the DSG system.

Additionally, the aquatic toxicity of the treatment composition is over 50 folds lower than that of conventional polyamine chemistry. The treatment composition of the present technology is more dilute (i.e. lower amount of polyamine results in lower polyamine content in a plant blow down water or a discharge water that may contaminate an underground water or a river water), and as such, minimizing the amount of polyamine present in the treatment will lower its environmental impact.

### EXAMPLES

The present technology will be further described in the following examples, which should be viewed as being illustrative and should not be construed to narrow the scope of the disclosed technology or limit the scope to any particular embodiment.

### Example 1

Two samples of water from a DSG system were used, wherein Sample “Water A” is the blowdown water sample from the DSG and Sample “Water B” is recycled feedwater for the DSG boiler. The analysis for each water sample is shown in Table 1, which provides a Water Analysis report of DSG water samples Water A and Water B.

TABLE 1

| | Water A (ppm,) | Water B (ppm) |
|---|---|---|
| Organic Components | | |
| Acetic Acid | 162 | 60.2 |
| Butyric Acid | <1.0 | <1.0 |
| Formic Acid | 2.7 | <1.0 |
| Glycolic Acid | <1.0 | <1.0 |
| Propionic Acid | 8.3 | 4.5 |
| Inorganic Components | | |
| Sodium as Na | <0.5 | <0.5 |
| Calcium as Ca | <0.10 | <10 |
| Magnesium as Mg | <0.05 | <0.05 |
| Total Iron as Fe | 0.03 | 0.04 |
| Total Hardness as CaCO₃ | <0.47 | <0.47 |
| Sulfur as SO₄ | 283 | 104 |
| Silica as SiO₂ | 0.72 | 0.32 |
| | pH = 8.2 | pH = 8.8 |

Electrochemical measurements were carried out using Gamry 600+ Potentiostat coupled with DC105™ Corrosion Techniques Software. Experiments were performed with a conventional three-electrode electrochemical cell and by employing the Rp/Ec trend technique. All tests were carried out for 24 hours at pH=8.2 to 8.8 and at T=22±0.2° C. (maintained with a recirculating water bath). A Teflon® liner was used to avoid filmer loss to the corrosion cell. The corrosion rates are measured in milli-inch per year (mpy). Pre-cleaned low carbon steel (LCS) coupons having a total surface area of 2.95 in² and a density of 7.87 g/cm³ were used for testing the corrosion inhibitor treatments.

Autoclave experiments were conducted using a Parr pressure vessel. Each test was carried out for 4 days at 185° C. (˜150 psig) with DSG water containing about 150 ppm of filmer. Ammonia was pre-mixed in test solution to achieve a pH range of 8.2 to 8.8 in both the vapor and liquid phases. For each run, vapor and liquid samples were collected at the regular interval. These samples were analyzed through the liquid chromatography-mass spectrometry (LC-MS) technique to determine the filmer concentration.

The volatility or V-L distribution properties of both DDSA and OSA were measured through the autoclave experiments using the DSG Water A sample at 185° C. (˜150 psig). Results are shown in Table 2 (V-L Distribution (Ka) of DDSA and OSA at 190 PSIG). The average Ka of both DDSA and OSA is around 10-2, which suggests that most of these components are primarily found in the liquid phase. Polyamine (N-propylamino-octadec-9-en-1-amine) is highly volatile having a Ka measurement around 6 at similar pressure.

TABLE 2

| | | Vapor | Liquid | | Average |
|---|---|---|---|---|---|
| Component | Day | (ppm) | (ppm) | K_{d} | K_{d} |
| Dodecynyl | 1 | 1.6 | 165 | 0.010 | 1.33E−02 |
| Succinic | 2 | 1.8 | 177 | 0.010 | |
| Acid | 3 | 2.8 | 190 | 0.015 | |
| (DDSA) | 4 | 3.5 | 190 | 0.018 | |
| Octenyl | 1 | 1.3 | 69 | 0.019 | 1.93E−02 |
| Succinic | 2 | 1.9 | 86 | 0.022 | |
| Acid | 3 | 1 | 86 | 0.012 | |
| (OSA) | 4 | 2.4 | 97 | 0.025 | |

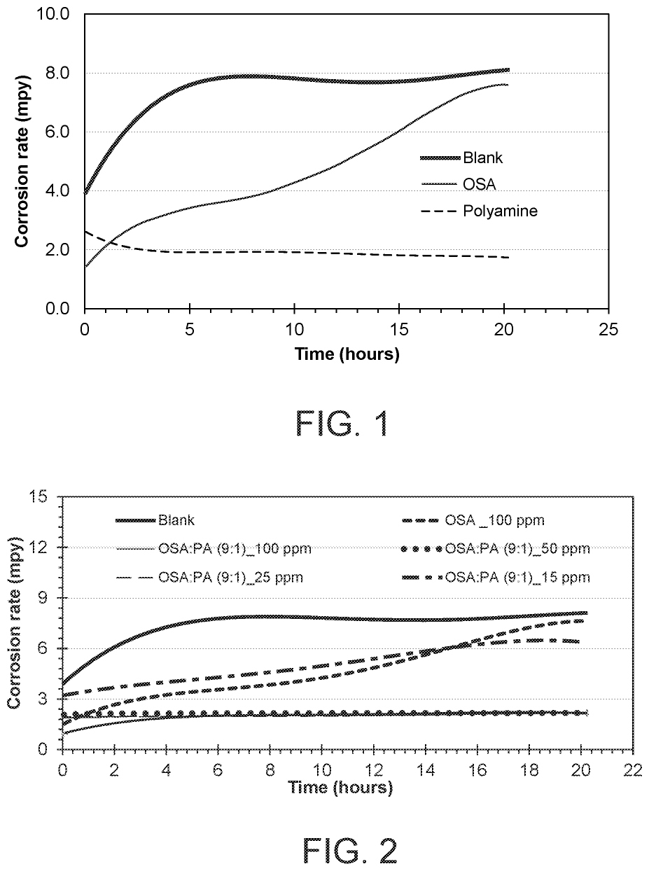

FIG. 1 shows the electrochemical results of LCS coupons in DSG Water B containing 100 ppm active of octenyl succinic acid (OSA), N-propylamino-octadec-9-en-1-amine) (Polyamine) or no treatment (Blank). Both the OSA and Polyamine samples are shown to inhibit corrosion, but the OSA sample is not as robust as the Polyamine sample.

FIG. 2 shows the electrochemical results of LCS coupons in DSG Water B containing 100 ppm active of octenyl succinic acid (OSA) and a blend of OSA and Polyamine (N-propylamino-octadec-9-en-1-amine) in a 9:1 molar ratio. The OSA: Polyamine (9:1) combination was measured at active treatment levels of 15 ppm, 25 ppm, 50 ppm and 100 ppm. A Blank sample without treatment was also measured.

FIG. 2 shows the corrosion rates of the LCS coupons in DSG water B sample. As demonstrated in FIG. 2, a synergy exists between OSA and Polyamine. For the OSA sample, the corrosion rate is initially low, but increases to 8 mpy and the OSA sample is similar to the Blank sample at 20 hours. The OSA: Polyamine (9:1) combination provides enhanced corrosion protection and limits the corrosion rate to around 2 mpy during the experimental runtime of 20 hours for treatment levels of 25 ppm, 50 ppm and 100 ppm. Even at a treatment level of 15 ppm, the OSA: Polyamine (9:1) combination is as effective as the OSA sample, which is at a treatment level of 100 ppm.

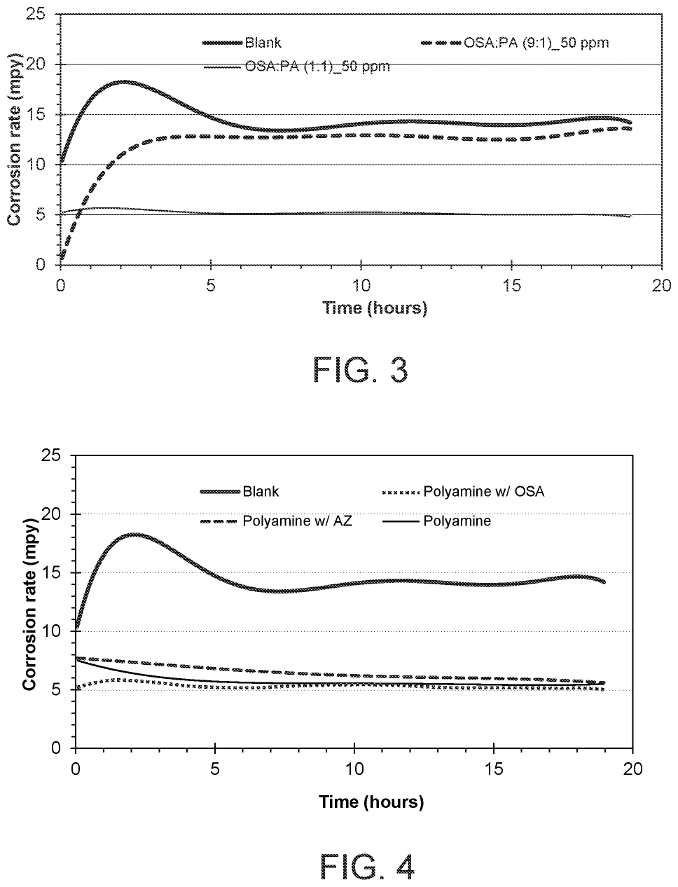

FIG. 3 shows the electrochemical results of LCS coupons in DSG Water A containing 50 ppm active of a blend of OSA and Polyamine (N-propylamino-octadec-9-en-1-amine) in a 9:1 molar ratio and 50 ppm active of a blend of OSA and Polyamine in a 1:1 molar ratio. A Blank without treatment was also measured.

FIG. 3 shows the corrosion rates of the LCS coupons in the DSG water A sample. The DSG Water A sample is a sample of blowdown water from the DSG system and contains more contaminants (over two times higher) than the DSG Water B recycled feedwater sample and is more corrosive. The higher corrosion is reflected on the Blank corrosion rates. The overall corrosion rate of the Blank sample in the DSG Water B sample is around 8 mpy (shown in FIG. 2), but the corrosion rate of the Blank sample is as high as 16 mpy in the DSG Water A sample (FIG. 3).

While the OSA: Polyamine (9:1) combination provided enhanced corrosion protection in the DSG Water B (feedwater) sample, the OSA: Polyamine (9:1) combination was not as effective in the DSG Water A (blowdown) sample. However, the OSA: Polyamine (1:1) combination effectively treated the highly corrosive DSG Water A sample and reduced the overall corrosion rate to 5 mpy, which is about three times lower than that of the Blank sample under similar conditions.

FIG. 4 shows the electrochemical results of LCS coupons in DSG Water A containing 50 ppm active of a Comparative Polyamine sample (N-propylamino-octadec-9-en-1-amine), a blend of Polyamine and nonanedioic acid, and a blend of Polyamine and Octenyl Succinic Acid) in 1:1 molar ratio. A Blank without treatment was also measured. The Polyamine active content for each of the treatment samples is shown in Table 3, which provides the total amount of Polyamine present at 50 ppm active of each treatment.

TABLE 3

| | Active Concentration | Polyamine Content |
|---|---|---|
| Treatment | (ppm) | (ppm) |
| Polyamine | 50 | 50 |
| Polyamine/AZ | 50 | 37 |
| Polyamine/OSA (1:1) | 50 | 25 |

As shown in FIG. 4, the treatment combination of Polyamine and nonanedioic acid and the treatment combination of Polyamine and OSA provide similar or better corrosion protection as the Comparative Polyamine sample at 50 ppm. As shown in Table 3, the treatment combination of Polyamine and nonanedioic acid and the treatment combination of Polyamine and OSA use reduced amounts of Polyamine, 37 ppm (26% reduction) and 25 ppm (50% reduction), respectively, and both treatment samples provide similar or better corrosion protection as the Comparative Polyamine sample at 50 ppm. This demonstrates the synergism that exists between the polyamine component and the diacid component.

### Example 2

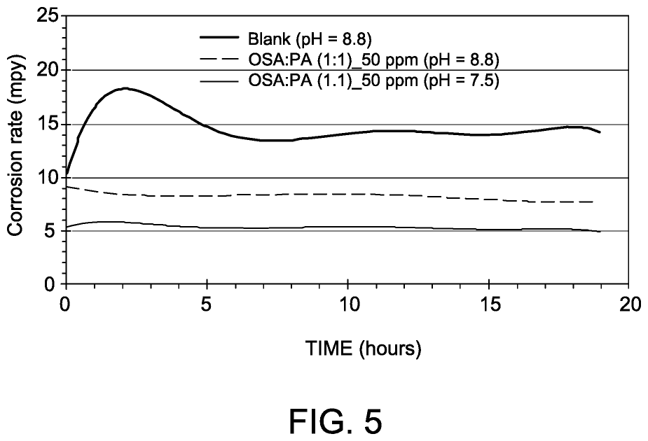

FIG. 5 shows the electrochemical results of LCS coupons in DSG Water A containing 50 ppm active of a combination of Polyamine (N-propylamino-octadec-9-en-1-amine) and Octenyl Succinic Acid (OSA) in 1:1 molar ratio where (1) the pH of the DSG Water A sample was adjusted to 8.8; and (2) where the pH of the DSG Water A sample was adjusted to 7.5. A Blank without treatment was measured in the Water A sample where the pH was adjusted to 8.8.

FIG. 5 shows that the treatment combination of Polyamine and OSA provides corrosion protection at the near neutral pH of ˜7.5. Although not shown, a Blank without treatment at a pH of 7.5 would be expected to exhibit higher corrosion rates as those exhibited by the treatment combination of Polyamine and OSA at pH of 7.5.

While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

What is claimed is:

1. A treatment composition, the composition comprising a fatty amine and a diacid, wherein the diacid comprises a succinic acid or a linear saturated dicarboxylic acid having the formula: HO₂C(CH₂)ₙCO₂H, wherein n is a positive integer of at least 6.

2. The treatment composition of claim 1, wherein the fatty amine comprises a polyamine having a hydrocarbon chain of at least 12 carbon atoms.

3. The treatment composition of claim 1, wherein the fatty amine comprises a diamine having a C₁₂-C₁₈ hydrocarbon chain.

4. The treatment composition of claim 1, wherein the diacid comprises a succinic acid.

5. The treatment composition of claim 4, wherein the succinic acid comprises octenyl succinic acid or dodecenyl succinic acid.

6. The treatment composition of claim 1, wherein n is in a range from 7 to 18.

7. The treatment composition of claim 1, wherein the fatty amine comprises a 9-ene-N-propylamino-1-octadenamine.

8. The treatment composition of claim 2, wherein the composition comprises a polyamine and octenyl succinic acid.

9. The treatment composition of claim 8, wherein a molar ratio of the fatty amine to the di-acid is in a range of from about 1:100 to about 100:1.

10. The treatment composition of claim 1, wherein the treatment composition is water soluble.

11. A method for controlling corrosion and/or deposit formation along structural parts of a dilution steam generator system, the method comprising adding a treatment composition to an aqueous medium, wherein the treatment composition comprises a fatty amine and a diacid, wherein the diacid comprises a succinic acid or a linear saturated dicarboxylic acid having the formula: HO₂C(CH₂)ₙCO₂H, wherein n is a positive integer of at least 6.

12. The method of claim 11, wherein the treatment composition forms a film on the structural parts of a liquid section and a vapor section of the dilution steam generator system.

13. The method of claim 11, wherein the fatty amine comprises a polyamine with a hydrocarbon chain having at least 12 carbon atoms.

14. The method of claim 11, wherein the fatty amine comprises a diamine having a C₁₂-C₁₈ hydrocarbon chain.

15. The method of claim 11, wherein the diacid comprises a succinic acid.

16. The method of claim 15, wherein the succinic acid comprises octenyl succinic acid or dodecenyl succinic acid.

17. The method of claim 11, wherein the fatty amine comprises a 9-ene-N-propylamino-1-octadenamine.

18. The method of claim 11, wherein the treatment composition comprises a polyamine and octenyl succinic acid.

19. The method of claim 18, wherein a molar ratio of the fatty amine and the di-acid is in a range of from about 1:100 to about 100:1.

20. The method of claim 11, wherein the treatment composition is water soluble.

21. A method for preparing a treatment composition, the method comprising mixing a fatty amine with a diacid, wherein the diacid comprises a succinic acid or a linear saturated dicarboxylic acid having the formula: HO₂C(CH₂)ₙCO₂H wherein n is a positive integer of at least 6.

22. The method of claim 21, wherein the treatment composition is water soluble.
